(19) United States
(12) Patent Application Publication
(10) Pub. No.: US 2026/0009261 A1
(43) Pub. Date: Jan. 8, 2026

(54) Adjustable Latch and Anti-Card System

(71) Applicant: Salto Systems, S.L., Oiartzun (ES)

(72) Inventors: Gorka Darceles Arrieta, Oiartzun (ES); Fermín Menta San Miguel, Oiartzun (ES)

(21) Appl. No.: 19/259,479

(22) Filed: Jul. 3, 2025

(30) Foreign Application Priority Data
Jul. 5, 2024 (ES) P202430566

(51) Int. Cl. E05B 17/20

(52) U.S. Cl. CPC E05B 17/2053; E05B 17/2084

(57) ABSTRACT

The present disclosure relates to a latch including an adjustable anti-card system, as well as to a latch with a length that is also adjustable. Additionally, the present disclosure relates to a door including a latch such as the one mentioned.

### CROSS-REFERENCE TO RELATED APPLICATION

This application claims priority to Spanish Patent Application No. P202430566, filed Jul. 5, 2024, the disclosure of which is hereby incorporated by reference in its entirety.

### BACKGROUND OF THE INVENTION

### Field of the Invention

The present disclosure relates to a latch comprising an adjustable anti-card system, as well as to a latch with a length that is also adjustable.

Additionally, the present disclosure relates to a door comprising a latch such as the one mentioned.

### Description of Related Art

In the technical field of latches, anti-card systems are known, which allow the movement of the bolt, or head, of the latch to be blocked when it is inside the strike plate of the door frame, thereby preventing the latch from being released from the frame in the event of an attempt to manipulate it, allowing the unwanted opening of the door.

In the state of the art, said anti-card systems are located in the front part of the latch, i.e. in the area of the latch closest to the bolt. Said position means that the length of the bolt of the latch has to be reduced, which leads to only a small part of said bolt being housed inside the body of the latch when the bolt is located inside the strike plate of the frame (active position or locked position, i.e. door closed), which weakens the lock by weakening the attachment between the bolt and the door frame and generates reliability problems.

Moreover, in the state of the art there are known latches that have a system that allows them to vary their length to adapt to the door where they are going to be installed. That is, the length of the latch is modified in dependence of the spacing between the edge of the door and the handle that operates the latch.

However, in the state of the art, some of these systems for adapting the length of the latch are located in the rear part of the latch, i.e. in the area of the latch furthest away from the bolt, which interferes with the actuation of the follower, comprising a weak drive system, thus resulting in a weak latch with reduced performance.

There are also latches with the system for adapting the length and the anti-card system, both located in the front part thereof. This position requires very complex systems to configure the latch, which makes it very expensive, in addition to generating problems in its operation due to the complexity of the mentioned systems.

In this way, the measures existing in the known state of the art allow, in very specific cases, there to be an adjustable latch, while maintaining the security provided by the installation of an anti-card system, through configurations which reduce the performance of said latches.

### SUMMARY OF THE INVENTION

The present disclosure allows the problems mentioned above to be solved by means of a latch comprising a more efficient anti-card system, as well as a latch comprising a length regulation system, while the anti-card system also allows its length to be adjusted, thus easily adapting to the length established for the latch.

A first inventive aspect therefore relates to a latch configured to provide a security lock on a door, characterised in that it comprises:
at least one body extending according to a longitudinal direction X-X′, and comprising a first end and a second end,
a bolt, at least partially housed at the first end of the at least one body, and
an anti-card system, comprising:
   activation means, at least partially housed in the at least one body and coupled to the bolt, said activation means extending according to the longitudinal direction X-X′ and being configured to be displaced along said longitudinal direction X-X′,
   an activation strip, housed in the at least one body and coupled to the activation means, comprising at least one first projection and at least one second projection, said activation strip extending according to said longitudinal direction X-X′ and being configured to be displaced along the longitudinal direction X-X′,
   locking means, housed in the at least one body, comprising a locking surface, located in a position close to the first end of the body, and a locking shaft, located in a position close to the second end of the body, wherein:
   the locking shaft is attached to the at least one body, and
   the locking surface is configured to pivot relative to the locking shaft between a first position essentially parallel to the longitudinal direction X-X′ and a second position inclined relative to the longitudinal direction X-X′,
   a displacement strip, housed in the at least one body, comprising at least one first projection and at least one second projection, said displacement strip extending according to the longitudinal direction X-X′ and being configured to be displaced along the longitudinal direction X-X′, and
   at least one displacement means, housed in the at least one body, wherein the activation means are at least partially housed in the displacement means, and wherein the displacement strip is attached to the displacement means, wherein the anti-card system is configured to adopt two positions along the longitudinal direction X-X′:
a first active position, or door closed position, wherein:
   the activation means are displaced according to the longitudinal direction X-X′ towards the second end of the at least one body, being completely housed in said at least one body,
   the at least one second projection of the activation strip is displaced according to the longitudinal direction X-X′ towards the second end of the at least one body, and
   the displacement means are configured such that the at least one second projection of the displacement strip, in its displacement according to the longitudinal direction X-X′, contacts the locking surface, which is in its first position, thus preventing the displacement according to the longitudinal direction X-X′ of the bolt, or
a second inactive position, or door open position, wherein:
   the activation means are aligned with the bolt and located at least partially outside of the at least one body,
   the at least one second projection of the activation strip is in contact with the locking surface, said locking surface being held in its second position, and
   the at least one second projection of the displacement strip and the locking surface are misaligned, thus allowing displacement according to the longitudinal direction X-X′ of the bolt.

According to the present inventive aspect, the latch comprises firstly a body extending longitudinally between a first end and a second end, both located on said longitudinal direction X-X′, and between which all the elements of said latch are located.

The latch also comprises a bolt, which is located at the first end of said body and is configured to adopt two positions:
a first position in which it is partially outside the body, and wherein the portion of the bolt that is outside the body is housed in a strike plate of a frame of a door, and
a second position, in which it is completely housed in the body during the door opening operation, i.e. outside the strike plate of the door frame.

In a particular embodiment, the bolt further comprises at least one rod. Said at least one rod is configured to be housed in a through hole of said bolt.

In a particular embodiment, the at least one body is cylindrical and coaxial with the longitudinal direction X-X′.

In a particular embodiment, the at least one body is configured by means of attaching a plurality of parts, in particular, the body is configured in two halves, which are coupled together. Advantageously, this allows for easier assembly of the latch.

In a particular embodiment, the at least one body comprises a plurality of slots located correspondingly in said two halves, which advantageously allows an analogous arrangement of the elements in the at least one body.

In a particular embodiment, the at least one body comprises a sleeve configured to house the plurality of parts making up the at least one body, for example, the two halves. Advantageously, this allows a configuration of the body of the latch by means of an attachment of independent elements, which allow a relative movement relative to one another, thus increasing the functionality of the configuration of said latch.

The latch of the present inventive aspect in turn comprises an anti-card system, with a specific configuration.

In particular, said anti-card system comprises activation means, which are at least partially housed in the at least one body and coupled to the bolt. In this way, the activation means perform a relative movement with respect to the movement of the bolt, such that they also adopt the two positions established for the bolt.

Thus, the activation means can be displaced along the longitudinal direction X-X′ together with the bolt, such that it is either completely housed in the at least one body or else is at least partially housed in the at least one body. In these cases, the movement of the activation means is integral with the movement of the bolt.

However, the activation means are also configured to perform a relative movement with respect to the movement of the bolt, such that said activation means are completely housed in the at least one body while the bolt is partially housed in said at least one body.

In this way, the activation means are located in a position close to the first end of the at least one body in the case of being at least partially housed in the at least one body, and in a position close to the second end of the at least one body in the case of being completely housed in the at least one body.

Similarly, the anti-card system comprises an activation strip located after said activation means in relation to the longitudinal direction X-X′ and in a position further away from the first end, extending along said longitudinal direction X-X′. Additionally, the activation strip is coupled to the activation means.

In a particular embodiment, the coupling between the activation means and the activation strip is established such that the activation means comprise a plurality of holes and the activation strip comprises a plurality of protrusions, wherein each of the plurality of protrusions is configured to be housed in one of the plurality of holes, respectively.

In this way, the movement along the longitudinal direction X-X′ of the activation means and the activation strip is joint and integral.

In a particular embodiment, the housing of a protrusion in a corresponding hole defines a position of the anti-card system corresponding to a predetermined length of the latch. That is, the different holes and the corresponding protrusions define different positions of the latch based on different lengths of said latch, such that each attachment between one of the plurality of holes and one of the plurality of protrusions defines a position of the anti-card system corresponding to a predetermined length of the latch. In this way, each of the protrusions has a corresponding hole, based on the attachment with which it allows a predetermined length of the anti-card system to be defined.

Advantageously, this allows a precise and efficient adjustment of the position of the anti-card system based on the longitudinal configuration of the latch, which in turn allows greater adaptability of the anti-card system to the corresponding position of the latch.

The activation strip comprises at least one first projection and at least one second projection, both located in the position furthest away from the first end of the at least one body, i.e. in the position closest to the second end of the at least one body.

Then, the locking means are inside the at least one body, and also in relation to the longitudinal direction X-X′, allowing interaction with the activation strip.

In particular, the locking means comprise a locking surface, located in the portion of the locking means closest to the first end of the at least one body.

Similarly, the locking means also comprise a shaft allowing said locking means, and in particular said locking surface, to pivot between two predetermined positions, allowing or not allowing the displacement of the bolt along the longitudinal direction X-X′.

In this way, the locking surface is configured to adopt the following positions:
a first position, wherein the locking surface is positioned essentially parallel to the longitudinal direction X-X′, and
a second position, wherein the locking surface adopts an inclined position relative to the longitudinal direction X-X′, i.e., forming a certain angle relative to said longitudinal direction X-X′.

The position of the locking surface and, therefore, of the locking means, determine the configuration of the anti-card system and, therefore, the operation of the present latch.

In particular, the locking shaft of the locking means is attached to the at least one body of the latch.

In a particular embodiment, the attachment between the locking shaft and the at least one body is an articulated attachment.

Moreover, the anti-card system also comprises a displacement strip, housed in the at least one body and located after the bolt and essentially parallel to the activation strip in relation to the longitudinal direction X-X′, extending along said longitudinal direction X-X′ and configured to be displaced along same.

The displacement strip comprises at least one first projection and at least one second projection, both located in the position furthest away from the first end of the at least one body, i.e. in the position closest to the second end of the at least one body.

Additionally, the anti-card system comprises displacement means, housed in the at least one body, wherein the activation means are at least partially housed in the displacement means, and wherein the displacement strip is attached to the displacement means.

In a particular embodiment, the attachment between the displacement means and the displacement strip is a screwed, riveted or equivalent attachment.

In this way, the anti-card system can adopt two positions along the longitudinal direction X-X′.

On the one hand, the anti-card system can adopt a first active position, i.e. a position wherein the door is closed, or a locked position, wherein the following conditions are verified:
The activation means are displaced according to the longitudinal direction X-X′ towards the second end of the at least one body, being completely housed in said at least one body. That is, the activation means remain inside the at least one body after their displacement according to the longitudinal direction X-X′ from their position close to the first end to their position close to the second end, independently of the movement of the bolt, which is displaced together with said activation means to be housed completely inside the at least one body, to return afterwards to their initial position at least partially outside the at least one body, and housed in the door frame, through the strike plate, when said door is closed.
The at least one second projection of the activation strip is displaced according to the longitudinal direction X-X′ towards the second end of the at least one body, such that said displacement allows a pivoting movement of the locking surface, which in turn allows said locking surface to alternate between its first and second positions. In this way, the second projection of the activation strip is supported on a surface of the locking means parallel to and away from the locking surface, therefore being in a position close to the locking shaft of said locking means.
The displacement means are configured such that the at least one second projection of the displacement strip, in its displacement according to the longitudinal direction X-X′, contacts the locking surface which is in its first position, thus preventing the displacement according to the longitudinal direction X-X′ of the bolt. That is, the position of the second projection of the activation strip positions the locking means and, therefore, the locking surface by means of a pivoting movement of said locking surface, such that the second projection of the displacement strip contacts said locking surface as displacement along the longitudinal direction X-X′ of the displacement strip occurs, such that said displacement is not possible, which in turn prevents displacement of the bolt according to the same direction, i.e. from its position closest to the first end of the at least one body towards the second end of the at least one body.

Advantageously, this first active position, which implies a door closed position, prevents unwanted opening of the door by means of manipulation of the movement of the bolt by a user. That is, the first active position (door closed position) of the anti-card system blocks the movement of the bolt according to the longitudinal direction X-X′, thus preventing it from being housed in the at least one body and, therefore, preventing the door from being opened.

Moreover, the anti-card system can adopt a second inactive position, i.e. a position wherein the door is open, wherein the following conditions are verified:
The activation means are aligned with the bolt and located at least partially outside of the at least one body. That is, the activation means and the bolt are in the same position, this being the position closest to the first end of the at least one body, which allows the displacement of both elements according to the longitudinal direction X-X′ from said first end towards the second end of the at least one body when the door is closed.
The at least one second projection of the activation strip is in contact with the locking surface, such that the pivoting movement which allows the locking surface to change its position is prevented by said contact, said locking surface thus being held in its second position. That is, the pivoting movement of the locking surface is blocked by the second projection of the activation strip, said locking surface being positioned forming a certain angle with the longitudinal direction X-X′ and without the possibility of said position being modified.
The at least one second projection of the displacement strip and the locking surface are misaligned, such that the displacement according to the longitudinal direction X-X′ of the displacement strip and, therefore, the movement of the bolt according to the longitudinal direction X-X′, is allowed.

That is, the locking means allow, by means of contact between their locking surface and the displacement strip, the anti-card system to be activated (door closed position) and, therefore, allow the latch to be in a locked position, which advantageously prevents unwanted opening of the door.

Therefore, in the first active position (door closed position), or locking position, of the anti-card system, the bolt is outside of the at least one body, the bolt being housed in the door frame, thus allowing the closed position of the door and being secured by means of the locking established by the anti-card system.

In a particular embodiment, the anti-card system further comprises first elastic means, located between the locking means and the at least one body. In particular, said first elastic means are supported on the locking means, in the same plane defined by the locking surface, but in a position away from the locking surface and close to the locking shaft.

In this way, the first elastic means are configured to limit the movement of the locking means, said first elastic means being:
under compression in the second inactive position (door open position) of the anti-card system, and
at rest in the first active position (door closed position) of the anti-card system.

Thus, in the second inactive position of the anti-card system (door open position), the position of at least one second projection of the activation strip on the locking means prevents the locking surface from pivoting around the locking shaft, and therefore positions said locking surface such that it allows the displacement of both the displacement rail and the bolt.

In a particular embodiment, the first elastic means are a compression spring.

Advantageously, this allows the first elastic means to exert a force on the locking means, such that said force must be released, thus overcoming the force exerted, through the movement of the established mechanism, to allow the anti-card system to change position.

In a particular embodiment, the locking surface comprises a tapering profile, or trough, configured to facilitate the rotation of the locking means as the at least one second projection of the activation strip is displaced over said locking surface when transitioning from the second inactive position of the anti-card system, i.e. the door open position, to the first active position of the anti-card system, i.e. the door closed position, which advantageously allows a better transition between the two possible positions established.

In a particular embodiment, the anti-card system further comprises second elastic means, located between the at least one first projection of the activation strip and the at least one body and configured to limit the movement of said activation strip, wherein said second elastic means are:
under compression in the first active position (door closed position) of the anti-card system, and
at rest in the second inactive position (door open position) of the anti-card system.

Thus, the second elastic means allow the activation means to return from their active position, completely housed in the at least one body, to their rest position, aligned with the bolt, when the door transitions from being closed to being open.

In a particular embodiment, the second elastic means are a compression spring.

Advantageously, this allows the second elastic means to exert a force on the activation strip when returning from their compression position to their rest position, such that they displace said activation strip from its established position in the active position of the anti-card system, i.e. closer to the second end of the at least one body, along the longitudinal direction X-X′, towards the first end of the at least one body.

In a particular embodiment, the locking means comprise a sliding surface opposite the locking surface and pushing means located contiguous to the sliding surface and essentially parallel to the locking shaft.

Advantageously, this allows a configuration of the locking means which allows the locking surface to be positioned in its first and/or second position in an efficient manner by means of the interaction of the elements of said locking means with other elements of the present latch.

In a particular embodiment, the anti-card system further comprises unlocking means, which in turn comprise:
at least one follower that is essentially cylindrical and configured to rotate, comprising a plurality of third projections and at least one recess, wherein said recess is located on the surface opposite the plurality of third projections, and
at least one actuator, comprising at least one fourth projection configured to be housed in the at least one recess of the follower, and an actuation shaft.

The actuator is configured to pivot about the actuation shaft between a first position of the follower and a second position of the follower, and is further configured to house the pushing means of the locking means.

Advantageously, this allows the follower to modify the position of the anti-card system, in particular by acting on the corresponding mechanism of the latch such that the anti-card system modifies its first active position, transitioning to its second inactive position, and thus allowing the displacement of the bolt according to the longitudinal direction X-X′ and, therefore, the opening of the door by dislodging the bolt from the frame of said door.

In this way, the positions of the unlocking means comply with the following relationships:
In the first position of the follower, the fourth projection of the actuator is housed in the at least one recess of the follower and the anti-card system is in its first active position, i.e. when the door is closed. That is, the present position of the follower and of the anti-card system simultaneously prevent the movement of the bolt according to the longitudinal direction X-X′, while keeping said bolt locked and its movement prevented by the anti-card system, in particular by the contact established between the locking surface of the locking means and the second projection of the displacement strip.
In the second position of the follower, the fourth projection of the actuator is removed from the at least one recess of the follower, such that, on the one hand, at least one of the plurality of third projections of the follower is displaced such that it contacts the at least one first projection of the displacement strip, and the actuator in turn moves the pushing means of the locking means, such that contact between the locking surface of the locking means and the second projection of the displacement strip is prevented, allowing the displacement of said second projection of the displacement strip according to the longitudinal direction X-X′, i.e. the anti-card system transitions to its second inactive position.
That is, the present position of the follower allows the movement of the bolt according to the longitudinal direction X-X′, while keeping said bolt unlocked and its movement being allowed by the anti-card system, in particular because the movement of the displacement strip according to the longitudinal direction X-X′ is allowed.

Therefore, said configuration of the anti-card system advantageously allows the possibility of unlocking the locking established by this anti-card system on the movement of the bolt in a voluntary and controlled manner, for example, opening the door from the inside through a handle of the latch, housed in the follower.

In this way, the movement made on the handle is transmitted to the follower, thus allowing its partial rotation and the movement of the connected elements.

In a particular embodiment, the actuator further comprises a first surface, wherein the sliding surface of the locking means is configured to slide over said first surface of the actuator.

In a particular embodiment, the actuator further comprises a pushing surface configured to house the pushing means of the locking means, such that said locking means and the actuator of the unlocking means are coupled to one another. In particular, the locking means rotate relative to the locking shaft.

Advantageously, this allows the unlocking means to cause, with the movement of the follower, a corresponding movement on the locking means, which allows action on the position of the anti-card system.

In a particular embodiment, the unlocking means further comprise third elastic means, located coaxially to the actuation shaft of the actuator, wherein said third elastic means are:
under compression in the second position of the follower, and
at rest in the first position of the follower.

Thus, the force exerted by the third elastic means allows the actuator to return, said actuator therefore remaining in its initial position when the follower transitions from its second position to its first position, which causes the third elastic means to transition from a state under compression to a state at rest, driving the actuator back to its initial position during this change of state. That is, the position of the actuator returns to its place when the rotational movement applied by the pushing of the follower upon rotation of same ceases, by means of the force exerted by the third elastic means.

In a particular embodiment, the third elastic means are a tension spring.

In a particular embodiment, the latch further comprises adjustment means configured to adjust the length of the at least one body, wherein said adjustment means comprise a stop, housed in at least one slot of the at least one body, such that it defines the length of said at least one body.

In this way, the stop of the adjustment means is configured to be housed in a corresponding slot of the at least one body, its position being fixed, and its configuration allowing the at least one body to comprise a degree of freedom of movement relative to rotation about said stop and the longitudinal direction X-X′, such that said at least one body is displaced to the desired length, its position being fixed by means of housing the stop in the corresponding slot.

In a particular embodiment, the stop of the adjustment means is simultaneously housed both in the sleeve of the at least one body and in one of the slots of said at least one body.

Advantageously, the adjustment means allow the length of the latch to be adjusted in conjunction with the anti-card system, which is also adjusted based on the desired length of the latch.

In a particular embodiment, the lengths of the latch are 60 mm or 70 mm.

In a particular embodiment, as an additional system for adjusting the length of the latch, the displacement strip comprises at least two holes configured to house the rod of the bolt.

In this way, the rod of the bolt is housed in the corresponding hole of the displacement strip, the position of the bolt thus being fixed relative to the displacement strip, which kinematically links the corresponding elements, which will have an integral movement in relation to the longitudinal direction X-X′.

In a particular embodiment, the displacement means of the anti-card system further comprise a through pocket configured to allow the movement of the rod of the bolt in dependence of its different positions, established by means of the holes configured in the displacement strip.

In a particular embodiment, the pocket of the displacement means is configured to house the at least one rod of the bolt, wherein the rod of the bolt is configured to be displaced along the pocket in a manner corresponding to the at least two holes of the displacement strip.

In this way, the length of the latch is optimally adjusted, allowing the bolt to be adjusted to the corresponding positions by means of a suitable transition of the movement of the individual elements.

In a particular embodiment, the latch further comprises a faceplate coupled to the at least one body and configured to cover the elements housed in said at least one body.

In a particular embodiment, the coupling between the faceplate, the at least one body and the door is by means of a screwed attachment.

Advantageously, said faceplate not only allows the protection of the elements present inside the at least one body, but further prevents any manipulation of said elements by a user.

A second inventive aspect relates to a door comprising a latch according to the first inventive aspect.

Advantageously, this allows a door with a more reliable and secure latch to be obtained.

### BRIEF DESCRIPTION OF THE DRAWINGS

To complete the description, and for the purpose of helping to make the features of the present disclosure more readily understandable, this specification is accompanied by a set of figures constituting an integral part of the same, which by way of illustration and not limitation represents the following:

FIG. 1A shows an exploded view of a latch according to a first exemplary embodiment.

FIG. 1B shows an elevational view of the latch lock shown in FIG. 1A.

FIGS. 2A and 2B show cross-section views of a latch according to the first exemplary embodiment shown in FIG. 1A, showing the door open position.

FIGS. 3A and 3B show a cross-section view and a detail view of the change from the first to the second position of an anti-card system of a latch according to the first exemplary embodiment shown in FIG. 1A, i.e. the change from an open door to a closed door.

FIGS. 4A-4C show detailed section views of an assembled latch according to the first exemplary embodiment shown in FIG. 1A.

FIGS. 4D-4G also show detailed section views of an assembled latch according to the first exemplary embodiment shown in FIG. 1A, in particular views of the corresponding positions of the follower of the unlocking means. In particular, FIG. 4D shows the arrangement of elements in the first position of the follower, while FIGS. 4E and 4F show the arrangement of elements in the second position of the follower. FIG. 4G shows a rear perspective view of the elements wherein the follower is also in its second position.

FIGS. 5A-5B show perspective views of a latch according to the first exemplary embodiment shown in FIG. 1A.

FIGS. 6A-6B show elevational views of the first and second positions, respectively, of an adjustable latch according to the first exemplary embodiment shown in FIG. 1A.

FIGS. 7A-7C show perspective views of the change from the first to the second position of an adjustable latch according to FIGS. 6A-6B.

### DESCRIPTION OF THE INVENTION

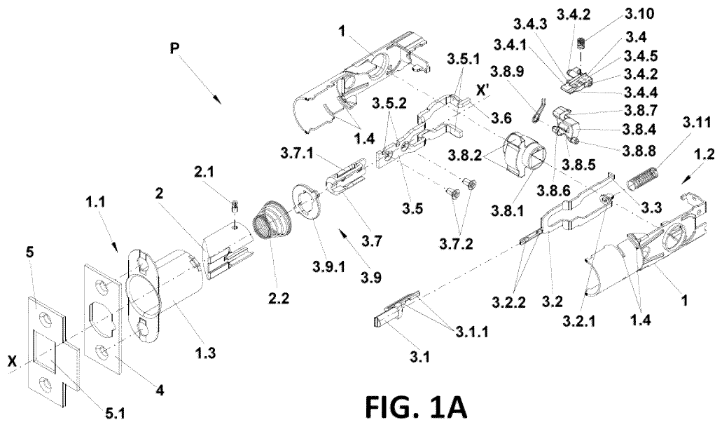

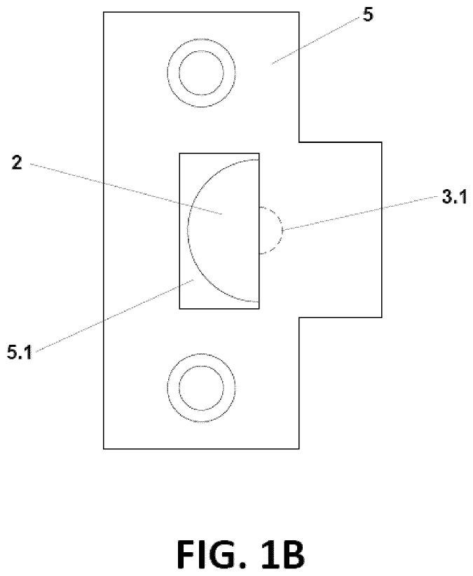

FIG. 1A shows an exploded view of an adjustable latch (P), comprising an adjustable anti-card system (3). This figure shows in detail the different elements that make up the first exemplary embodiment of an adjustable latch (P).

In particular, it can be seen how said latch (P) extends according to the longitudinal direction X-X′ between the first end (1.1) and second end (1.2).

In particular, the body (1) is configured by means of two portions (1), coupled to one another, together with a sleeve (1.3) encompassing said two coupled portions (1), forming a tubular configuration, and the complete body (1) extending between the first end (1.1) and second end (1.2) in relation to the longitudinal direction X-X′.

In this way, as can be seen, two of the portions of the body (1) are configured to be coupled to one another, each of said portions of the body (1) comprising a series of slots (1.4) located on the surface of each of the portions (1) of the body (1) coupled to one another.

In turn, the sleeve (1.3) of the body (1) of the latch (P) shown is coupled, at the first end (1.1), with a faceplate (4), which allows the coupling of the latch (P) in a door.

Likewise, the latch (P) shown comprises a bolt (2) with a rod (2.1), wherein the bolt (2) is configured to be housed between the portions (1) of the body (1) and inside the sleeve (1.3) of the body (1) and to pass through the faceplate (4) to be housed, in the operational position, in the hole (5.1) of the strike plate (5) of the corresponding door frame, said strike plate (5) being shown in detail in FIG. 1B, wherein an elevational view is shown in the door closed position, such that the bolt (2) is housed in the hole (5.1) of the strike plate (5).

The bolt (2) in turn comprises a spring (2.2) configured to allow and fix the movement of the bolt (2) in relation to the longitudinal direction X-X′, it being particularly advantageous for the bolt (2) to automatically recover its position outside of the sleeve (1.3) of the body (1) after having previously been completely housed in the body (1).

FIG. 1A also shows an anti-card system (3), comprising activation means (3.1), which are housed in the corresponding space of the bolt (2), accompanying said bolt (2) in its movement in relation to the longitudinal direction X-X′, said movement being integral in its housing inside the sleeve (1.3) of the body (1), and independent in the case where the bolt (2) is outside of the sleeve (1.3) of the body (1) and the activation means (3.1) of the anti-card system (3) are completely housed in said body (1). That is, the activation means (3.1) and the bolt (2) form an integral part in one position in the case where they are housed together in the body (1), thus performing a common movement in relation to the longitudinal direction X-X′, being independent of one another and having a relative movement relative to one another in another one of the positions of both elements. Similarly, the activation means (3.1) are located in contact with the strike plate (5), outside its hole (5.1), as shown in FIG. 1B.

Additionally, the activation means (3.1) comprise holes (3.1.1), in this case two holes (3.1.1).

FIG. 1A also shows an activation strip (3.2), located after, in relation to the longitudinal direction X-X′, the activation means (3.1), therefore being in a position closer to the second end (1.2) than said activation means (3.1).

Said activation strip (3.2) extends according to the longitudinal direction X-X′ and is fork-shaped, comprising a first projection (3.2.1) and, in turn, a second projection (3.3), both located at its end furthest away from the activation means (3.1) and, therefore, at its end closest to the second end (1.2).

Additionally, the activation strip (3.2) comprises protrusions (3.2.2), in this case two protrusions (3.2.2), which are located in correspondence with the two holes (3.1.1) of the activation means (3.1). Said protrusions (3.2.2) and holes (3.1.1) allow two positions of the anti-card system (3) to be defined through their coupling, when the anti-card system (3) and the latch (P) are mounted and in the operational position.

As can be seen, FIG. 1A also shows second elastic means (3.11), in this case a compression spring (3.11), which clasps the first projection (3.2.1) of the activation strip (3.2) and which, in the operational position of the latch (P), is limited in its movement by an inner surface of the body (1).

Moreover, FIG. 1A shows locking means (3.4), comprising a locking surface (3.4.1) and a locking shaft (3.4.2) around which said locking means (3.4) pivot.

Similarly, the locking means (3.4) in turn comprise pushing means (3.4.3) configured in the form of a pin, and a sliding surface (3.4.4) located in the position opposite the locking surface (3.4.1).

The present FIG. 1A also shows first elastic means (3.10), in particular a compression spring (3.10), supported on the locking means (3.4) and limited in their movement by an inner surface of the body (1).

Similarly, and in an analogous position with respect to the longitudinal direction X-X′, FIG. 1A shows a displacement strip (3.5) extending according to said longitudinal direction X-X′ and being fork-shaped.

The displacement rod (3.5) in turn comprises two first projections (3.5.1) and a second projection (3.6), all of which are located at the end thereof furthest away from the activation means (3.1) and, therefore, at the end thereof closest to the second end (1.2).

As can be seen, the anti-card system (3) is located in the rear part of the latch (P), away from the first end (1.1) of the body (1), unlike the usual configurations in the state of the art.

In this way, the activation strip (3.2), the displacement strip (3.5) and the locking means (3.4) interact with one another to define the different positions of the anti-card system (3).

Moreover, between the activation strip (3.2) and the bolt (2), there are adjustment means (3.9) configured by means of a stop (3.9.1) in the form of a washer with a protuberance. Said stop (3.9.1) is housed in the sleeve (1.3) of the body (1) and is located contiguous to the spring (2.2) of the bolt (2), its position being fixed with respect to said sleeve (1.3) of the body (1).

The adjustment means (3.9) are, as already indicated, located between the activation strip (3.2) and the bolt (2), all their elements being housed inside the body (1), in particular, inside the sleeve (1.3) of said body (1).

In particular, the stop (3.9.1) of the adjustment means (3.9) is in turn housed in one of the slots (1.4) of the portions (1) of the body (1). In this way, the position of the stop (3.9.1) with respect to the two slots (1.4) of the body (1) allows the length of the latch (P) to be defined, the adjustment means (3.9) thus adjusting the length of the latch (P).

The protrusion of the stop (3.9.1) is located, in the mounted position of the latch (P), on the outer part of the sleeve (1.3) of the body (1), such that it is accessible for a user from the outside of the latch (P).

Additionally, the stop (3.9.1) is located adjacent to displacement means (3.7), which are fixed to the displacement strip (3.5) by means of a screwed attachment (3.7.2), which allows the movement of said displacement means (3.7) and the displacement strip (3.5) with respect to the longitudinal direction X-X′ to be integral. In an exemplary embodiment not shown, the attachment (3.7.2) may be a riveted attachment, or an attachment equivalent to the screwed or riveted attachment.

Similarly, the displacement means (3.7) comprise a pocket (3.7.1), along which the rod (2.1) of the bolt (2) is displaced, in dependence of its position, adjusted by means of the holes (3.5.2). That is, based on the required length of the latch (P), the rod (2.1) of the bolt (2) is displaced along the longitudinal direction X-X′ and housed in one of the holes (3.5.2) of the displacement strip (3.5), whereby the position of said rod (2.1) is fixed and, therefore, the length of the latch (P) is established.

Moreover, and in correspondence with the two portions (1) of the body (1), FIG. 1A shows, also positioned along the longitudinal direction X-X′, unlocking means (3.8) configured by means of a follower (3.8.1) configured to house a handle of the latch (P) in its central square through hole.

In this way, the follower (3.8.1) is housed inside the portions (1) of the body (1), in turn comprising a square through hole configured to receive said handle of the latch (P), as has been indicated.

As can be seen, the follower (3.8.1) is essentially cylindrical and comprises on one side third projections (3.8.2), in this case two third projections (3.8.2) projecting according to a diameter greater than that of the follower (3.8.1).

In one embodiment, not depicted, the follower (3.8.1) is divided in half, according to the vertical plane containing the longitudinal direction X-X′, in two sections, such that a different actuation relationship is obtained according to whether the follower (3.8.1) is actuated from the outer side or from the inner side of the door.

Similarly, and although not seen in FIG. 1A, the follower (3.8.1) comprises a recess (3.8.3) on the side opposite the two third projections (3.8.2).

After said follower (3.8.1), the unlocking means (3.8) also comprise an actuator (3.8.4), located in a position closer to the second end (1.2) than the follower (3.8.1), comprising a fourth projection (3.8.5) configured to interact with the recess (3.8.3) of the follower (3.8.1) in dependence of the position adopted by the handle of the latch (P).

This configuration allows the follower (3.8.1) to rotate in both directions, i.e. to rotate to the right or to the left according to the orientation shown in the present figure, and in both rotations to cause the same displacement of the actuator (3.8.4) when the fourth projection (3.8.5) is displaced in both cases in the same way due to the interaction with the recess (3.8.3). Therefore, this configuration allows this lock to be installed on both right-opening doors and left-opening doors, i.e. it makes the lock reversible.

That is, the fourth projection (3.8.5) is housed inside the recess (3.8.3) or not, in dependence of the position of the handle of the latch (P) and therefore of the position of the actuator (3.8.4), which pivots around the actuation shaft (3.8.8) of said actuator (3.8.4), which in turn causes a change in the position of the anti-card system (3), which is in its first active position or in its second inactive position, respectively. The third elastic means (3.8.9), in this case a tension spring (3.8.9), allow recovery of the position of the actuator (3.8.4).

Additionally, the actuator (3.8.4) also comprises a first surface (3.8.6) and a pushing surface (3.8.7), both configured to interact with the locking means (3.4) in the mounted position of the latch (P). That is, the first surface (3.8.6) and the pushing surface (3.8.7) interact with the locking means (3.4). In particular, the first surface (3.8.6) interacts with the sliding surface (3.4.4) of the locking means (3.4), allowing the sliding of both elements with respect to one another, while the interaction of the pushing surface (3.8.7) with said locking means (3.4) allows the modification of their position, which in turn modifies the position of the anti-card system (3).

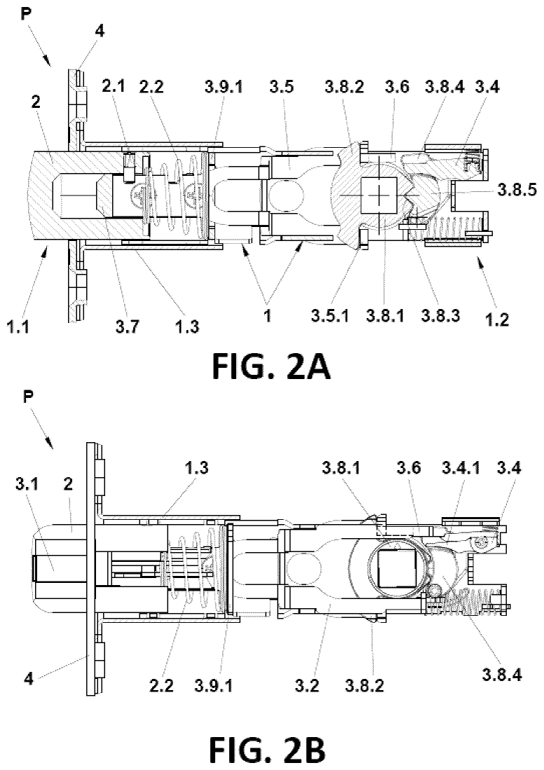

All of these elements, once mounted and in the operational position, configure a latch (P) as shown in the section views of FIGS. 2A and 2B.

In this way, FIG. 2A shows a cross-section view of a mounted latch (P), such that it is possible to see the configuration of the different elements shown in FIG. 1A, in this case in the door open position.

Thus, FIG. 2A shows the different portions (1) and the sleeve (1.3) of the complete body (1) mounted and coupled to one another, as well as attached to the faceplate (4) at the first end (1.1) thereof.

The components of the body (1) extend along the longitudinal direction X-X′ and house between their first end (1.1) and second end (1.2) the regulation means (3.9), of which the stop (3.9.1) and the spring (2.2) of the bolt (2), as well as the displacement strip (3.5), can be seen. In particular, as can be seen, the spring (2.2) clasps a section of said displacement strip (3.5) and of the displacement means (3.7), at the end thereof closest to the first end (1.1) of the body (1).

Additionally, FIG. 2A also shows the actuator (3.8.4) and its fourth projection (3.8.5) housed in the recess (3.8.3) of the follower (3.8.1), as well as the square through hole that said follower (3.8.1) comprises for housing the handle of the latch (P).

Analogously, FIG. 2B shows a cross-section view of the same latch (P), in particular the different portions of the body (1) and the sleeve (1.3), all mounted and coupled to one another, as well as attached to the faceplate (4) at the first end (1.1) thereof.

The different elements of the body (1) extend, as in the previous case, along the longitudinal direction X-X′, and house between their first end (1.1) and second end (1.2) the different elements, showing the bolt (2) and the activation means (3.1), both projecting outside of the sleeve (1.3) and the hole in the faceplate (4).

Similarly, the position of the stop (3.9.1) and of the spring (2.2) as well as the position of the follower (3.8.1), the actuator (3.8.4) and the locking means (3.4) are seen.

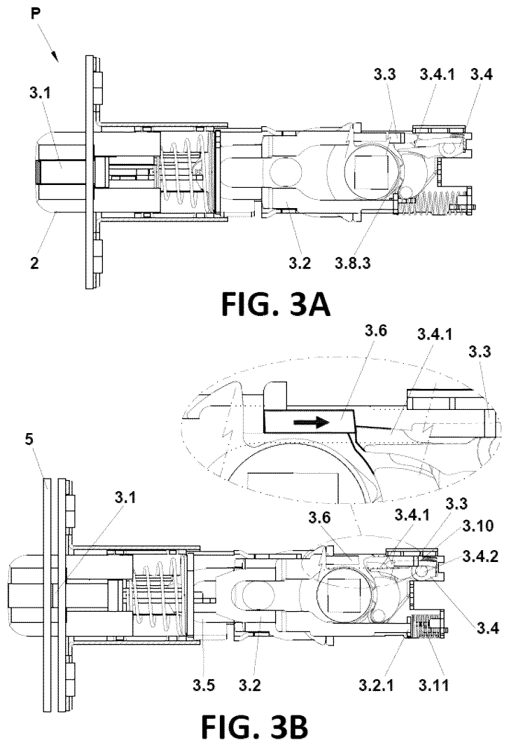

Analogously, FIG. 3A shows a cross-section view of the same latch (P) as FIGS. 2A and 2B, i.e. it shows the door open position, wherein the second projection (3.3) of the activation strip (3.2) is resting on the locking surface (3.4.1), corresponding to the second inactive position of the anti-card system (3), i.e. door open position, while the first projection (3.2.1) of said activation strip (3.2) is supported on the second elastic means (3.11), which in turn abut with the second end (1.2) of the body (1), said second elastic means (3.11) being at rest and the bolt (2) being outside of the sleeve (1.3).

Moreover, FIG. 3B shows a cross-section view of the latch (P), wherein the anti-card system (3) is in its first active position, i.e. it shows a door closed position, which is seen because the second projection (3.3) of the activation strip (3.2) is located away from the locking surface (3.4.1), and because the locking means (3.4) are in a position parallel to the longitudinal direction X-X′ based on their pivoting about their locking shaft (3.4.2).

In this case, the present figure also shows the first projection (3.2.1) of the activation strip (3.2) supported on the second elastic means (3.11), in this case in a compressed state, which in turn abut with the second end (1.2) of the body (1) as in the case of the previous figure.

Finally, the detail shown in FIG. 3B shows, by means of an arrow pointing from the first end (1.1) towards the second end (1.2) of the body (1), how the second projection (3.6) of the displacement strip (3.5) has the capacity to be displaced, according to the longitudinal direction X-X′, towards the second end (1.2) of the body (1), while the locking surface (3.4.1) of the locking means (3.4) prevents this movement according to the longitudinal direction X-X′ given that the anti-card system (3) is in the first active position of the anti-card system (3), i.e. showing the door closed position.

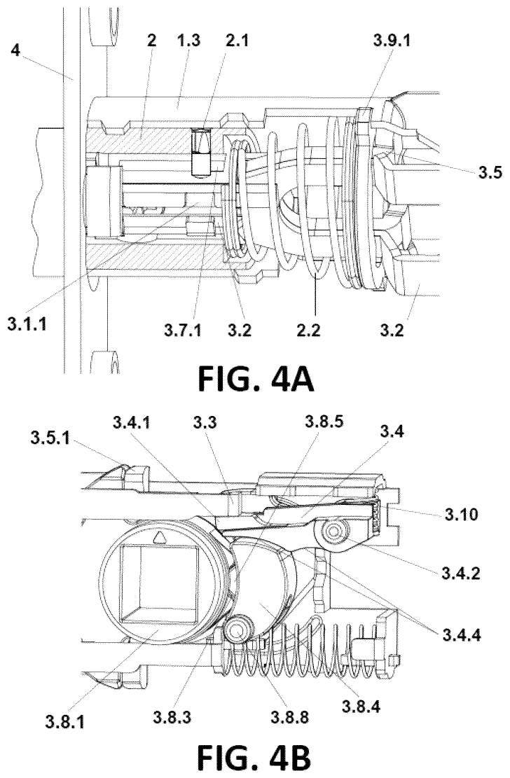

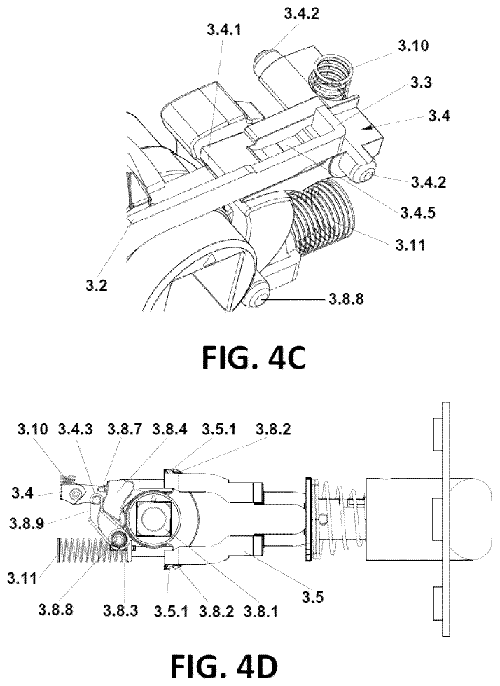

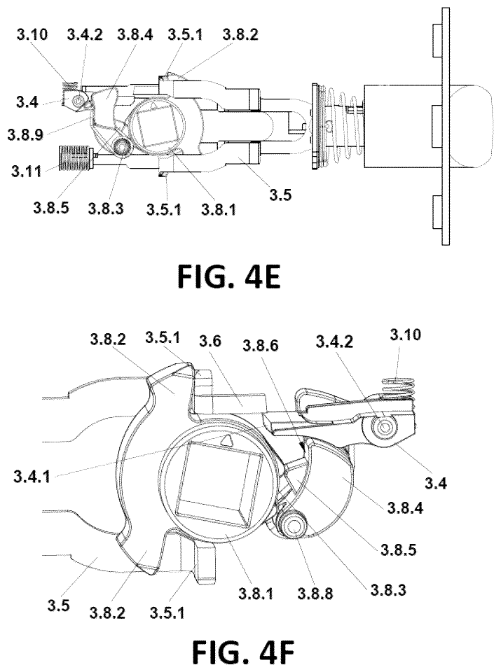

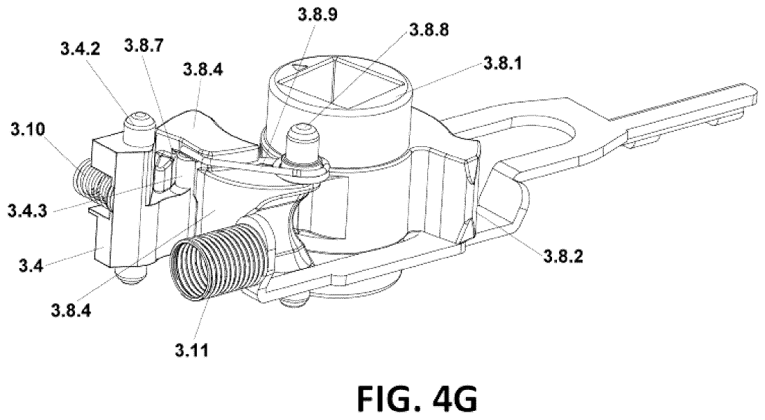

Additionally, FIGS. 4A-4D respectively show detail views of a latch (P) according to the first exemplary embodiment shown in FIGS. 1-3.

In particular, FIG. 4A shows the rod (2.1) of the bolt (2) which is housed in the pocket (3.7.1) of the displacement means (3.7). Additionally, the spring (2.2) of the bolt (2) is shown at rest around said displacement means (3.7) and the stop (3.9.1) of the adjustment means (3.9), in turn partially clasping the displacement strip (3.5), such that the present figure also shows the activation strip (3.2) and the displacement strip (3.5) in their position relative to the inside of the body (1).

Moreover, FIG. 4B shows in detail a portion of the latch (P) closest to the second end (1.2) of the body (1), showing the door open position, showing in particular the configuration of the locking means (3.4) on which the second projection (3.3) of the activation strip (3.2) is supported, which opposes the pivoting movement of said locking means (3.4) about their locking shaft (3.4.2) by the force exerted by the first elastic means (3.10) compressed in the present figure.

The locking surface (3.4.1) of the locking means (3.4) is also shown when the anti-card system (3) is in its second inactive position, i.e. in the door open position.

Finally, FIG. 4B also shows the position of the first projections (3.5.1) of the displacement strip (3.5), as well as the position of the actuator (3.8.4) in relation to its actuation shaft (3.8.8), wherein its fourth projection (3.8.5) is housed in the recess (3.8.3) of the follower (3.8.1).

FIG. 4C shows a top view of a portion of the latch (P) closest to the second end (1.2) of the body (1), in the active position, or situation wherein the door is closed, which allows the locking surface (3.4.1) as well as the locking shaft (3.4.2) of the locking means (3.4), passing through said locking means (3.4), to be seen from another perspective. In this figure, the second projection (3.3) of the activation strip (3.2) has been displaced towards the second end (1.2) of the body (1), thereby allowing the locking surface (3.4.1) to pivot about the locking shaft (3.4.2) pushed by the first elastic means (3.10), said elastic means (3.10) being in their rest position in this figure.

FIG. 4D shows the same situation as in FIG. 4C, such that the fourth projection (3.8.5) of the actuator (3.8.4) is housed in the recess (3.8.3) of the follower (3.8.1), the follower (3.8.1) therefore being in its first position. The present figure shows, as can be seen, a triangular mark located on the top part of the follower (3.8.1), centred relative to the square through hole of the follower (3.8.1) which houses the door handle (not shown).

In this way, the third elastic means (3.8.9), which are a torsion spring (3.8.9) at rest, can be seen.

Similarly, it can be seen that the actuator (3.8.4) does not make contact with the locking means (3.4).

FIG. 4E shows a view analogous to FIG. 4D, wherein the follower (3.8.1) is in its second position, such that the triangular mark located in the top part of the follower (3.8.1) in FIG. 4D is now shown rotated relative to its previous centred position and, therefore, rotated by the shaft of the door handle (not shown).

In this way, FIG. 4E shows the anti-card system (3) in its active position, i.e. showing a door closed position, and the follower (3.8.1) of the unlocking means (3.8) rotated by the action of a force exerted by the door handle, housed in the square through hole of the follower (3.8.1).

That is, the door handle allows a rotation of the follower (3.8.1), equivalent to the change of position of the triangular mark mentioned above, which causes the recess (3.8.3) of the follower (3.8.1) to push the fourth projection (3.8.5) of the actuator (3.8.4), such that said fourth projection (3.8.5) is removed from the recess (3.8.3), which in turn causes the rotation of the actuator (3.8.4) on its actuation shaft (3.8.8).

Additionally, the same rotational movement causes the locking means (3.4) to rotate about their locking shaft (3.4.2) by means of the pushing surface (3.8.7) of the actuator (3.8.4) being driven over the pushing means (3.4.3), such that said locking means (3.4) pivot, thus modifying the position of the locking surface (3.4.1) of the locking means (3.4), such that said locking surface (3.4.1) forms a certain angle with the longitudinal direction X-X′, allowing the displacement of the second projection (3.6) of the displacement strip (3.5) as well as the bolt (2) according to the longitudinal direction X-X′.

Moreover, FIG. 4F shows a detail of FIG. 4E, such that the displacement of the displacement strip (3.5) can be seen. It can also be seen how one of the two third projections (3.8.2) of the follower (3.8.1) is resting against a first projection (3.5.1) of the displacement strip (3.5), pushing against same when the follower (3.8.1) rotates due to the rotation of the handle of the latch (P) in the square through hole of said follower (3.8.1), the follower (3.8.1) therefore being in its second position.

FIG. 4G also corresponds to the position of the elements of the latch (P) shown in FIGS. 4E and 4F, in this case showing a perspective view of the rear part which allows a detailed view of the connection of the locking means (3.4) with the unlocking means (3.8).

As can be seen, the pushing surface (3.8.7) of the actuator (3.8.4) houses the pushing means (3.4.3) of the locking means (3.4), such that the movement of the actuator (3.8.4) described above, in dependence of the first or second position of the follower (3.8.1), drives said pushing means (3.4.3), which causes the locking means (3.4) to change position.

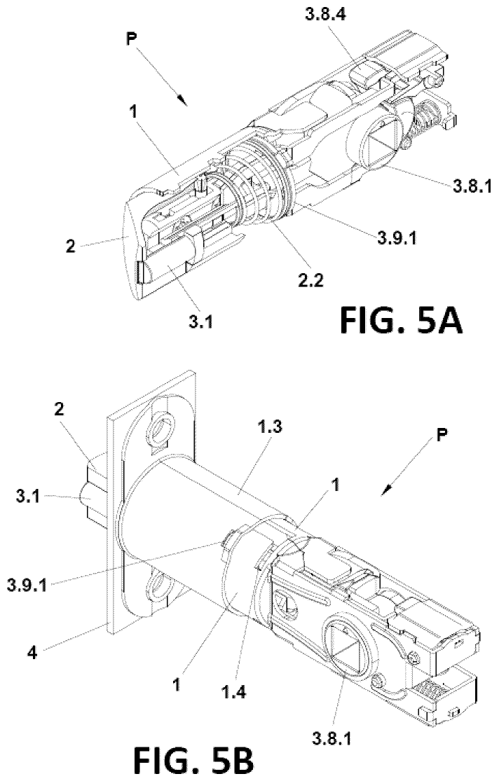

In relation to FIGS. 5A and 5B, these show perspective views of a latch (P) wherein, again, the mounting configuration of the elements configuring the latch (P) can be seen.

Said figures allow the slots (1.4) of the body (1) which allow the housing of the stop (3.9.1) of the adjustment means (3.9), as well as the position of the bolt (2) and the activation means (3.1), coupled to one another, to be seen in more detail.

The location of the stop (3.9.1) of the adjustment means (3.9) is also shown, wherein FIG. 5B shows said stop (3.9.1) and its protuberance in relation to the slots (1.4) of the body (1), in its most extended or longest position.

In particular, the stop (3.9.1) is housed in a slot (1.4) of the body (1) closest to the first end (1.1) of the body (1), while the other slot (1.4) closest to the second end (1.2) of the body (1) is free. This establishes one of the positions of the latch (P) in relation to its length.

That is, the stop (3.9.1) can be housed in either of the two slots (1.4) of the body (1), thus establishing two different positions, wherein one of them allows the latch (P) to have a greater length than the other one of the positions.

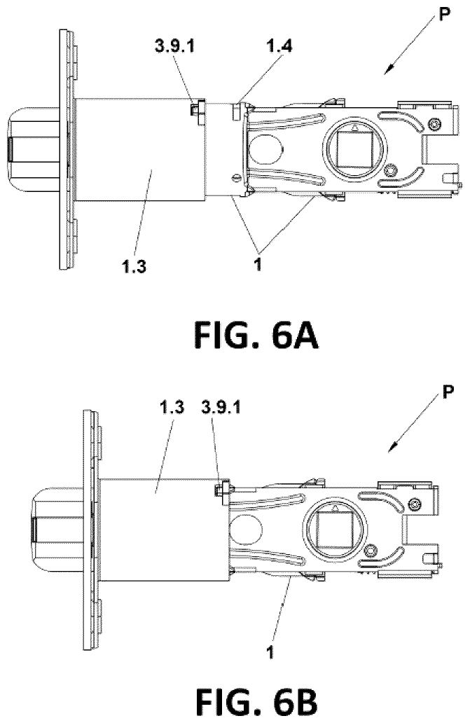

Said configuration is also visible in FIGS. 6A and 6B, which show elevational views of the first and second positions of the latch (P).

FIG. 6A shows a front view wherein the latch (P) is in its longest position, the stop (3.9.1) being housed in the slot (1.4) of the body (1) closest to the first end (1.1) of the body (1), such that it can be seen how the body (1) extends over a greater length along the longitudinal direction X-X′.

In this particular example, FIG. 6A corresponds to a length of the latch of 70 mm, measured from the faceplate (4) to the centre of the square through hole of the follower (3.8.1) where the handle of the latch (P) is housed.

FIG. 6B shows a front view wherein the latch (P) is in its shortest position, the stop (3.9.1) being housed in the slot (1.4) of the body (1) closest to the second end (1.2) of the body (1), such that it can be seen how the body (1) extends over a shorter length along the longitudinal direction X-X′ than in FIG. 6A.

In this particular example, FIG. 6B corresponds to a length of the latch of 60 mm, measured from the faceplate (4) to the centre of the square through hole of the follower (3.8.1) where the handle of the latch (P) is housed.

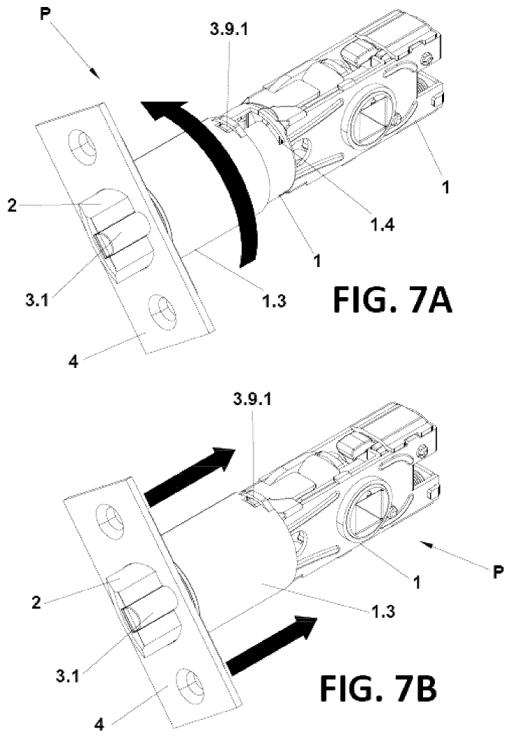

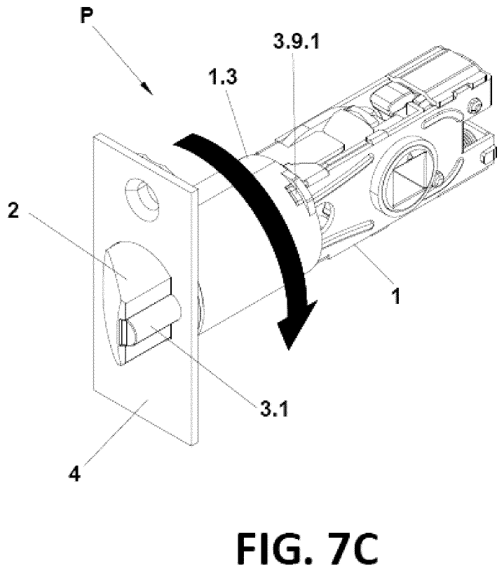

Finally, FIGS. 7A-7C show perspective views of the change from the first to the second position of an adjustable latch (P) according to FIGS. 6A-6B, i.e. starting from the position of FIG. 6A, the sequential operation to reach the position of FIG. 6B.

In particular, FIG. 7A shows how, by means of rotation of the sleeve (1.3) of the body (1), the stop (3.9.1) has been uncoupled from the slot (1.4) of the body in which it was housed in FIG. 6A.

FIG. 7B shows the movement of the portions (1) of the body (1) and the elements housed therein, in relation to the longitudinal direction X-X′, from the first end (1.1) of the body (1) towards the second end (1.2) of said body (1), therefore transitioning from the first to the second position of the latch (P), i.e. from the longest to the shortest position measured according to the longitudinal direction X-X′, the stop (3.9.1) thus remaining in the same position with respect to the faceplate (4), both in the first and in the second position of the latch (P).

Finally, FIG. 7C shows the rotation, in the opposite direction, of the sleeve (1.3) of the body (1) to couple the stop (3.9.1) in the slot (1.4) closest to the first end (1.1) of the body (1), thus fixing the position of the latch (P) at its shortest length.

As already specified above, the modification of the position of the latch (P) drives the rod (2.1) of the bolt (2) along the pocket (3.7.1) of the sliding means (3.7), such that the position thereof is also adapted in dependence of the length of the latch (P).

However, regardless of the length of the latch (P), the bolt (2) has a surface, outside of the faceplate (4), configured to be housed in the door frame, as well as a surface configured to be held inside the body (1), which is larger in size than those currently existing in the state of the art, increasing the security of the latch (P).

Therefore, by way of summary, the operation of this latch (P) relative to the adjustment of the anti-card system (3) and relative to the length of the latch (P) is as follows.

### Regulation and Operation of the Anti-Card System

The activation means (3.1) are responsible for activating the anti-card system (3), such that once the latch (P) is positioned to allow the closing of the door where the latch (P) is housed, i.e. when the bolt (2) is housed in the hole (5.1) of the strike plate (5) of the door frame, said strike plate (5) prevents the movement, according to the longitudinal direction X-X′, of the activation means (3.1), such that they remain inserted inside the sleeve (1.3) of said body (1), thus displacing the activation strip (3.2) according to the longitudinal direction X-X′, from the first end (1.1) of the body (1) towards the second end (1.2) of the body (1), based on the connection established between the activation means (3.1) and the activation strip (3.2) by the interaction of the holes (3.1.1) and the protrusions (3.2.2).

Likewise, the configuration adopted by said holes (3.1.1) and protrusions (3.2.2) based on their coupling allows different positions of the anti-card system (3) to be established based on their length, which will be directly related to the length established for the latch (P), i.e. a longer position of the anti-card system (3) corresponds to a longer position of the latch (P) and vice versa.

Moreover, and in accordance with the movement according to the longitudinal direction X-X′ of the activation strip (3.2), the locking means (3.4) pivot around their locking shaft (3.4.2) articulated with the body (1) due to the displacement of the second projection (3.3) of said activation strip (3.2) on the locking means (3.4), allowing the pivoting movement of the locking surface (3.4.1) due to the release of energy of the first elastic means (3.10), such that the locking surface (3.4.1) is aligned with the direction of movement, or longitudinal direction X-X′, of the second projection (3.6) of the displacement strip (3.5), interfering with it and thus preventing the movement thereof based on the contact established between both elements.

In the contact position between the locking surface (3.4.1) and the second projection (3.6) of the displacement strip (3.5), the anti-card system (3) is in its first active position, or door closed position, thus preventing the bolt (2) from being displaced according to the longitudinal direction X-X′ and, therefore, preventing the door from being opened in an unauthorised manner, thus increasing the security of the latch (P) against malicious actions by users.

On the contrary, when the locking surface (3.4.1) is not aligned in the direction of movement, or longitudinal direction X-X′, of the second projection (3.6) of the displacement strip (3.5), thus creating a clearance between both elements, the second inactive position of the anti-card system (3), or door open position, is established, allowing the movement of the bolt (2) according to the longitudinal direction X-X′.

Moreover, the first active position of the anti-card system (3) can be modified to its second inactive position by means of the unlocking means (3.8).

In the case of the first active position of the anti-card system (3), or door closed position, and without acting on the follower (3.8.1), i.e. without causing the rotation of said follower (3.8.1) by means of the door handle in the square through hole of the follower (3.8.1), the fourth projection (3.8.5) of the actuator (3.8.4) is housed in the recess (3.8.3) of the follower (3.8.1).

In the case of the first active position of the anti-card system (3), or door closed position, when the handle of the latch (P) rotates inside the hole, square in this case, comprised in the follower (3.8.1) of said unlocking means (3.8), it drives said follower (3.8.1), which rotates such that the recess (3.8.3) of the follower (3.8.1) pushes the fourth projection (3.8.5) of the actuator (3.8.4), uncoupling it from the recess (3.8.3) of the follower (3.8.1), and causing said actuator (3.8.4) to rotate about its actuation shaft (3.8.8), compressing the third elastic means (3.8.9). In turn, when the actuator (3.8.4) rotates, it drives the locking means (3.4) due to the pushing performed by the pushing surface (3.8.7) of the actuator (3.8.4) on the pushing means (3.4.3) of the locking means (3.4), causing the locking means (3.4) to pivot on their locking shaft (3.4.2), such that the position of the locking surface (3.4.1) varies, becoming misaligned with the direction of movement of the second projection (3.6) of the displacement strip (3.5), thus allowing its displacement according to the longitudinal direction X-X′. For the displacement of the displacement strip (3.5), one of the two third projections (3.8.2) of the follower (3.8.1) rests against a first projection (3.5.1) of the displacement strip (3.5), which pushes against same when the follower (3.8.1) is rotated by means of rotating the handle of the latch (P) in the square through hole of said follower (3.8.1), thereby allowing the movement of the bolt (2) and, therefore, the opening of the door.

Subsequently, once the handle has stopped rotating and the follower (3.8.1) has returned to its initial position, the third elastic means (3.8.9) are released to their rest position by pushing the actuator (3.8.4) against the follower (3.8.1), the fourth projection (3.8.5) of the actuator (3.8.4) being inserted again into the recess (3.8.3) of the follower (3.8.1).

1. A latch configured to provide a security lock on a door, comprising:
at least one body extending according to a longitudinal direction X-X′, and comprising a first end and a second end,
a bolt, at least partially housed at the first end of the at least one body, and
an anti-card system, comprising:
activation means, at least partially housed in the at least one body and coupled to the bolt, said activation means extending according to the longitudinal direction X-X′ and being configured to be displaced along said longitudinal direction X-X′,
an activation strip, housed in the at least one body and coupled to the activation means, comprising at least one first projection and at least one second projection, said activation strip extending according to said longitudinal direction X-X′ and being configured to be displaced along the longitudinal direction X-X′,
locking means, housed in the at least one body, comprising a locking surface, located in a position close to the first end of the body, and a locking shaft, located in a position close to the second end of the body, wherein:
the locking shaft is attached to the at least one body, and
the locking surface is configured to pivot relative to the locking shaft between a first position essentially parallel to the longitudinal direction X-X′ and a second position inclined relative to the longitudinal direction X-X′,
a displacement strip, housed in the at least one body, comprising at least one first projection and at least one second projection, said displacement strip extending according to the longitudinal direction X-X′ and being configured to be displaced along the longitudinal direction X-X′, and
at least one displacement means, housed in the at least one body, wherein the activation means are at least partially housed in the displacement means, and wherein the displacement strip is attached to the displacement means,
wherein the anti-card system is configured to adopt two positions along the longitudinal direction X-X′:
a first active position, wherein:
the activation means are displaced according to the longitudinal direction X-X′ towards the second end of the at least one body, being completely housed in said at least one body,
the at least one second projection of the activation strip is displaced according to the longitudinal direction X-X′ towards the second end of the at least one body, and
the displacement means are configured such that the at least one second projection of the displacement strip, in its displacement according to the longitudinal direction X-X′, contacts the locking surface which is in its first position, thus preventing the displacement according to the longitudinal direction X-X′ of the bolt, or
a second inactive position, wherein:
the activation means are aligned with the bolt and located at least partially outside of the at least one body,
the at least one second projection of the activation strip is in contact with the locking surface, said locking surface being held in its second position, and
the at least one second projection of the displacement strip and the locking surface are misaligned, thus allowing displacement according to the longitudinal direction X-X′ of the bolt.

2. The latch according to claim 1, wherein the anti-card system further comprises first elastic means, located between the locking means and the at least one body, and configured to limit the movement of the locking means, wherein said first elastic means are:
under compression in the second inactive position of the anti-card system, and
at rest in the first active position of the anti-card system.

3. The latch according to claim 1, wherein the anti-card system further comprises second elastic means, located between the at least one first projection of the activation strip and the at least one body, and configured to limit the movement of said activation strip, wherein said second elastic means are:
under compression in the first active position of the anti-card system, and
at rest in the second inactive position of the anti-card system.

4. The latch according to claim 1, wherein the locking surface comprises a tapering profile configured to facilitate the rotation of the locking means when at least one second projection of the activation strip is displaced.

5. The latch according to claim 1, wherein the activation means comprise a plurality of holes and in that the activation strip comprises a plurality of protrusions, wherein the plurality of protrusions are configured to be housed in the plurality of holes, respectively.

6. The latch according to claim 5, wherein each housing of a protrusion in a corresponding hole defines a position of the anti-card system corresponding to a predetermined length of the latch.

7. The latch according to claim 1, wherein the attachment between the locking shaft and the at least one body is an articulated attachment.

8. The latch according to claim 1, wherein the attachment between the displacement means and the displacement strip is a screwed or riveted attachment.

9. The latch according to claim 1, wherein the locking means comprise a sliding surface opposite the locking surface and pushing means located contiguous to the sliding surface and essentially parallel to the locking shaft.

10. The latch according to claim 9, wherein the anti-card system further comprises unlocking means, which in turn comprise:
at least one follower that is essentially cylindrical and configured to rotate, comprising a plurality of third projections and at least one recess, wherein said recess is located on the surface opposite the surface on which the plurality of third projections are located, and
at least one actuator, comprising at least one fourth projection configured to be housed in the at least one recess of the follower, and an actuation shaft,
wherein the actuator is configured to pivot about the actuation shaft between a first position of the follower and a second position of the follower, and
wherein the actuator is configured to house the pushing means of the locking means, and wherein:
in the first position of the follower, the fourth projection of the actuator is housed in the at least one recess of the follower and the anti-card system is in its first active position, and
in the second position of the follower, the fourth projection of the actuator is removed from the at least one recess of the follower, such that:
the actuator moves the pushing means of the locking means such that contact between the locking surface of the locking means and the second projection of the displacement strip is prevented, and
at least one of the plurality of third projections of the follower contacts the at least one first projection of the displacement strip.

11. The latch according to claim 10, wherein the actuator further comprises a pushing surface configured to house the pushing means of the locking means.

12. The latch according to claim 10, wherein the unlocking means further comprise third elastic means, located coaxial with respect to the actuation shaft of the actuator, wherein said third elastic means are:
under compression in the second position of the follower, and
at rest in the first position of the follower.

13. The latch according to claim 1, wherein the at least one body is configured in two halves, and that it further comprises a sleeve configured to house said two halves and/or a plurality of slots positioned correspondingly in said two halves.

14. The latch according to claim 13, wherein it further comprises adjustment means configured to adjust the length of the at least one body, wherein said adjustment means comprise a stop configured to be housed in at least one slot of the at least one body such that it defines the length of said at least one body.

15. The latch according to claim 1, wherein the bolt comprises at least one rod.

16. The latch according to claim 15, wherein the displacement strip comprises at least two holes configured to house the rod of the bolt.

17. The latch according to claim 1, wherein the displacement means comprise a through pocket.

18. The latch according to claim 15, wherein the pocket of the displacement means is configured to house the at least one rod of the bolt, and in that the rod of the bolt is configured to be displaced along the pocket in a manner corresponding to the at least two holes of the displacement strip.

19. The latch according to claim 1, wherein the at least one body is cylindrical and coaxial with the longitudinal direction X-X′.

20. A door comprising a latch according to claim 1.
